(19) United States
(12) Patent Application Publication
(10) Pub. No.: US 2016/0005279 A1
(43) Pub. Date: Jan. 7, 2016

(54) DEVICE AND PACKAGE FOR RETAIL THEFT PREVENTION

(71) Applicant: Giovanni SALVO, Rosemère (CA)

(72) Inventor: GIOVANNI SALVO, Rosemère (CA)

(21) Appl. No.: 14/769,381

(22) PCT Filed: Feb. 20, 2014
(86) PCT No.: PCT/CA2014/000124

§ 371 Date: Aug. 20, 2015

Related U.S. Application Data
(60) Provisional application No. 61/766,850, filed on Feb. 20, 2013.

(51) Int. Cl. G08B 13/14

(52) U.S. Cl. CPC G08B 13/14

(57) ABSTRACT

A theft prevention assembly comprises a base and an alarm signaling device in order to signal an alarm when an attempt is made to remove the device from a package packaging an article or to remove the article from the package. The base is formed on the package which packages the article. The alarm-signaling device is mounted to the base. The device comprises a detector interfacing with the article for operative communication therewith. The detector provides for detecting an unauthorized distance between the device and the article. When the unauthorized distance is detected the device signals an alarm indicative of attempted theft. The device may also include sockets for receiving straps to be strapped to the package.

### CROSS-REFERENCE TO RELATED APPLICATIONS

The present application claims priority on U.S. Provisional Application No. 61/766,850, filed on Feb. 20, 2013, which is incorporated by reference in its entirety.

### TECHNICAL FIELD

The present disclosure relates to the prevention of theft in retail outlets. More particularly, but not exclusively, the present disclosure relates to a device and package for preventing retail theft.

### BACKGROUND

Retailers report that shoplifting has a significant effect on their bottom line, a significant amount of inventory disappears to shoplifters. Retail theft costs retailers millions of dollars a day. Retailers seek ways to prevent theft and make recovery possible when merchandise is attempted to be stolen.

There exist of a variety of tags that are mounted on item packages and boxes. These tags include resonating elements that when passed through the frequency emitting gates of a store an alarm is signaled. These tags are based on EAS (Electronic Article Surveillance) technology. Yet, thieves have uncovered ways of removing such tags stuck on boxes with an adhesive or source-tagged inside packaging by simply opening the boxes and packages to retrieve the merchandise. Removing EAS tags stuck outside boxes or inside on the actual product is easy to do without an alarm. It will be the same with RFID-EAS tags: smart tag gaining popularity in retail applications.

Defeating traditional EAS tags inside packages has also become easy for professionals who know they are often placed inside packages opposite bar-codes to aid cashiers locate the tags at the point of sale for deactivation concerns. There are hand-held deactivation units that deactivate and verify that the tags are deactivated.

Accordingly, later improvements include tags with wires that wrap the boxes or packages which contain a non-deactivatable tag. A drawback with these known systems is the labor and time costs associated with mounting such devices onto packaging. Significantly slowing down product to floor times and significantly increasing costs. Another drawback is that the wrap protects the package but does offer the possibility to protect the product itself directly. Another drawback is that merchandise presentation is affected since the positioning of the device is not too flexible and the wires diminish the marketing appeal of the packaging artwork and presentation. Also, when boxes are stacked the wrap which protrudes impedes boxes from sitting one up on top of each other evenly making presentation unappealing to the consumer (image of device placed inside recessed corrugated package cavity). Another drawback is that that wires do not wrap around well to certain packages, boxes desired to be protected. Another time-consuming drawback is that often employees do not rewind the wires after use and the wires get all tangled up. This increases the labor costs of having employees to take the time (to untangle them. Furthermore, this results in unprotected merchandise since the employees often cease trying to untangle the wraps, which is a difficult and cumbersome process

Tag pollution is an industry problem which has been created by merchandise which is source-tagged but ends up in stores that have no equipment to de-activate the tags. Customers end up leaving and going to other stores unintentionally setting off the systems. Employees face these tag pollution related alarms often and the result is that most often they stop taking alarms seriously.

Retailers want a high level of deterrence without the cumbersome, time-consuming and limiting security aspects of wires and other available products. Retailers are seeking solutions for higher levels of protection in which the product in the package itself is linked to an alarm tag. Moreover, retailers prefer tags that are simple (not cumbersome) to use, apply and store and that do not affect the ornamental features of the packaging.

There is a need in the market for moving away from the so-called blister packages which are responsible for the phenomenon known as wrap-rage. In fact there are thousands of injuries in the United States from people cutting themselves when trying to open such packages. As such, part of the market wishes to move to paper packages instead of plastic packages.

There thus remains a need for improvements in retail theft prevention.

### OBJECTS

An object of the present disclosure is to provide a device for preventing retail theft.

An object of the present disclosure is to provide a package for preventing retail theft.

An object of the present disclosure is to provide kit for preventing retail theft.

An object of the present disclosure is to provide a method for preventing retail theft.

### SUMMARY

In accordance with an aspect of the disclosure, there is provided theft prevention assembly comprising: a base formed on a package for packaging an article; and an alarm-signaling device for being mounted to the base, the device comprising a detector interfacing with the article for operative communication therewith, the detector providing for detecting an unauthorized distance between the device and the article, wherein when the unauthorized distance is detected the device signals an alarm indicative of attempted theft.

In an embodiment of the assembly, the base includes an opening for exposing the article therein thereby providing the operative communication between the detector and the article. In an embodiment of the assembly, the article and the detector interface at a junction defined by the base, wherein the base includes a window at the junction. In an embodiment of the assembly, the window comprises translucent material for permitting light to pass therethrough. In an embodiment of the assembly, the base formed on the package comprises an exterior surface area of the package. In an embodiment of the assembly, the base formed on the package comprises a recessed portion of the package for nesting the alarm-signaling device therein. In an embodiment of the assembly, the base formed on the package comprises an additional element mounted to the package. In an embodiment of the assembly, the base formed on the package comprises elements protruding from the package for receiving the alarm-signaling device.

In an embodiment of the assembly, detector comprises a movable pin member engaging the article via the opening. In an embodiment of the assembly, the detector comprises a movable wire member engaging the article via the opening. In an embodiment of the assembly, the detector comprises a light capturing element. In an embodiment of the assembly, the alarm signaling device, the article and the package provide for blocking external light from being captured by the light capturing element when there is an authorized distance between the alarm-signaling device and the article. In an embodiment of the assembly, the light capturing element captures light when there is an unauthorized distance between the alarm signaling device and the article. In an embodiment of the assembly, the light capturing element is configured to detect modifications in the light condition between the device and the article. In an embodiment of the assembly, detector comprises an infrared emitter/detector for determining the distance between the device and the article. In an embodiment of the assembly, the detector comprises a motion detector. In an embodiment of the assembly, the detector comprises an image capture device.

In accordance with an aspect of the present disclosure, there is provided a theft prevention kit comprising: a package for packaging an article therein, the package comprising an outer surface defining a base; and an alarm-signaling device for being mounted to the base, the device comprising a detector interfacing with the article for operative communication therewith, the detector providing for detecting an unauthorized distance between the device and the article, wherein when the unauthorized distance is detected the device signals an alarm indicative of attempted theft.

In an embodiment of the kit, the base includes an opening for exposing the article therein thereby providing the operative communication between the detector and the article. In an embodiment of the kit, the article and the detector interface at a junction defined by the base, wherein the base includes a window at the junction. In an embodiment of the kit, the window comprises translucent material for permitting light to pass therethrough. In an embodiment of the kit, the base formed on the package comprises an exterior surface area of the package. In an embodiment of the kit, the base formed on the package comprises a recessed portion of the package for nesting the alarm-signaling device therein. In an embodiment of the kit, the base formed on the package comprises an additional element mounted to the package. In an embodiment of the kit, the base formed on the package comprises elements protruding from the package for receiving the alarm-signaling device.

In an embodiment of the kit, the detector comprises a movable pin member engaging the article via the opening In an embodiment of the kit, the detector comprises a movable wire member engaging the article via the opening. In an embodiment of the kit, the detector comprises a light capturing element. In an embodiment of the kit, the alarm signaling device, the article and the package provide for blocking external light from being captured by the light capturing element when there is an authorized distance between the alarm-signaling device and the article. In an embodiment of the kit, the light capturing element captures light when there is an unauthorized distance between the alarm signaling device and the article. In an embodiment of the kit, the light capturing element is configured to detect modifications in the light condition between the device and the article. In an embodiment of the kit, the detector comprises an infrared emitter/detector for determining the distance between the device and the article. In an embodiment of the kit, the detector comprises a motion detector. In an embodiment of the kit, the detector comprises an image capture device.

In accordance with an aspect of the disclosure, there is provided a package for packaging an article therein comprising: a base structure formed on an outer surface of the package, the base structure providing for receiving an alarm-signaling device and comprising an inner wall for mating with an outer wall of the device; and an opening formed within a floor of the base for exposing the article within the package and for providing the device to directly engage the article, wherein unauthorized disengagement of the device from the article is causes the device to signal an alarm indicative of attempted theft.

In an embodiment of the package, the base formed on the package comprises a recessed portion of the package for nesting the alarm-signaling device therein. In an embodiment of the package, the base formed on the package comprises an additional element mounted to the package. In an embodiment of the package, the base formed on the package comprises elements protruding from the package for receiving the alarm-signaling device.

In an embodiment of the package, the device comprises a movable pin member engaging the article via the opening In an embodiment of the package, the device comprises a light capturing element engaging the article. In an embodiment of the package, the alarm signaling device, the article and the package provide for blocking external light from being captured by the light capturing element when there is engagement between the alarm-signaling device and the article. In an embodiment of the package, the light capturing element captures light when there is unauthorized disengagement between the alarm signaling device and the article. In an embodiment of the package, the light capturing element is configured to detect modifications in the light condition between the device and the article. In an embodiment of the package, the detector comprises an infrared emitter/detector for determining the distance between the device and the article. In an embodiment of the package, the detector comprises a motion detector. In an embodiment of the package, the detector comprises an image capture device.

In accordance with an aspect of the present disclosure, there is provided a package for packaging an article therein comprising: a base structure formed on an outer surface of the package, the base structure providing for receiving an alarm-signaling device and comprising an inner wall for mating with an outer wall of the device, a window formed within a floor of the base for allowing light to pass therethrough when the article within the package is at an unauthorized distance from the device when mounted to the base.

In an embodiment of the package, window comprises translucent material for permitting light to pass therethrough.

In an embodiment of the package, the base formed on the package comprises a recessed portion of the package for nesting the alarm-signaling device therein. In an embodiment of the package, the base formed on the package comprises an additional element mounted to the package. In an embodiment of the package, the base formed on the package comprises elements protruding from the package for receiving the alarm-signaling device.

In an embodiment of the package, the device comprises a light capturing element. In an embodiment of the package, the alarm signaling device, the article and the package provide for blocking external light from being captured by the light capturing element when there is an authorized distance between the alarm-signaling device and the article. In an embodiment of the package, the light capturing element captures light when there is an unauthorized distance between the alarm signaling device and the article. In an embodiment of the package, the light capturing element is configured to detect modifications in the light condition between the device and the article. In an embodiment of the package, the detector comprises an infrared emitter/detector for determining the distance between the device and the article. In an embodiment of the package, the detector comprises a motion detector. In an embodiment of the package, the detector comprises an image capture device. In an embodiment of the package, the package comprises pre-formed packaging material.

In an embodiment of the package, the preformed packaging material is opaque.

In accordance with an aspect of the present disclosure, there is provided a method of packaging an article comprising: providing an material for packaging the article therein; providing a translucent portion on the material for allowing viewing of the article therein; obscuring the remaining portion of the material so as to block external light from passing therethrough; providing an area on the remaining obscured portion of the material for allowing external light to pass therethrough; and mounting an alarm signaling device on the area so as to block external light from passing therethrough, the alarm signaling device comprising a light capturing element interfacing with the article, the alarm signaling device, wherein the article and the obscured package material provide for blocking external light from being captured by the light capturing element when there is an authorized distance between the alarm-signaling device and the article, wherein the light capturing element captures light when there is an unauthorized distance between the alarm signaling device and the article.

In an embodiment of the method, the area comprises a window. In an embodiment of the method, the window comprises translucent material In an embodiment of the method, the area comprises an opening.

In accordance with an aspect of the present disclosure, there is provided a method of packaging an article comprising: providing a material for packaging the article therein; forming a base structure on an outer surface of the material the base structure providing for receiving an alarm-signaling device and comprising an inner wall for mating with an outer wall of the device; providing an opening in a floor of the of the base for exposing the article within the package and for providing the device to engage the article.

In accordance with an aspect of the present disclosure, there is provided a method of packaging an article comprising: providing a material for packaging the article therein; forming a base structure on an outer surface of the material the base structure providing for receiving an alarm-signaling device and comprising an inner wall for mating with an outer wall of the device; providing a window in a floor of the of the base for allowing light to pass therethrough when the article within the package is at an unauthorized distance from the device when mounted to the base.

In accordance with an aspect of the present disclosure, there is provided a kit for theft prevention comprising: a cut-out element for forming an opening on a surface of a package packaging an article; and an alarm-signaling device for being mounted to the package, the device comprising a detector for operatively engaging the article via the opening, the detector providing for detecting an unauthorized distance between the device and the article, wherein when the unauthorized distance is detected the device signals an alarm indicative of attempted theft.

In accordance with an aspect of the present disclosure, there is provided a kit for theft prevention comprising: a package for packaging an article for material having a weak cut lines for being selectively removed to provide an opening exposing the article therein; and an alarm-signaling device for being mounted to the package, the device comprising a detector for operatively engaging the article via the opening, the detector providing for detecting an unauthorized distance between the device and the article, wherein when the unauthorized distance is detected the device signals an alarm indicative of attempted theft.

In accordance with an aspect of the present disclosure, there is provided a kit for theft prevention comprising: a device for being mounted on a package having an article therein and comprising sockets; and at least one strap for being positioned within the sockets and being strapped around the package.

In an embodiment, the kit further comprises a package having a base for receiving the device. In an embodiment, the kit further comprises a package having a cavity for receiving the device.

Without limitation, the term “package” or “packaging” also includes without limitation whatsoever to the broad definition thereof a box of any type of configuration or any other type of full or partial enclosure for housing, enclosing or otherwise mounting an item therein or thereto as is known in the art made by any type of material

Without limitation thereto, the term “article(s)” also includes the items for sale depending on the use of a particular device, or assembly of devices disclosed herein.

Other objects, advantages and features of the present disclosure will become more apparent upon reading of the following non-restrictive description of illustrative embodiments thereof, given by way of example only with reference to the accompanying drawings.

### BRIEF DESCRIPTION OF THE DRAWINGS

In the appended drawings:

FIG. 1 is a perspective view of a theft prevention device and a package for containing an article in an unassembled position in accordance with a non-restrictive illustrative embodiment of the present disclosure;

FIG. 2A is a perspective view of a theft prevention device and a package for containing an article in an unassembled position in accordance with another non-restrictive illustrative embodiment of the present disclosure;

FIG. 2B is FIG. 2A is a perspective view of a theft prevention device and a package for containing an article in an unassembled position in accordance with a further non-restrictive illustrative embodiment of the present disclosure;

FIG. 3A is a perspective view of the theft prevention device and the package for containing an article in an assembled position in accordance with a non-restrictive illustrative embodiment of the present disclosure;

FIG. 3B is a perspective view of the theft prevention device and the package for containing an article in an assembled position in accordance with another non-restrictive illustrative embodiment of the present disclosure;

FIG. 3C is a sectional view of the theft prevention device of FIG. 3B taken along the line 3C-3C;

FIG. 4A is a lateral sectional view of a theft prevention device in accordance with a non-restrictive illustrative embodiment of the present disclosure mounted to a package in accordance with a non-restrictive illustrative embodiment of the present disclosure;

FIG. 4B a lateral sectional view of the theft prevention device of FIG. 4A being removed from the package of FIG. 4A;

FIG. 4C is a lateral sectional view of a theft prevention device in accordance with a non-restrictive illustrative embodiment of the present disclosure mounted to a package in accordance with a non-restrictive illustrative embodiment of the present disclosure;

FIG. 4D a lateral sectional view of the theft prevention device of FIG. 4C being removed from the package of FIG. 4C;

FIG. 5 is a perspective view of another theft prevention device and a package for containing an article in an unassembled position in accordance with another non-restrictive illustrative embodiment of the present disclosure;

FIG. 6 is perspective view of a further theft prevention device and a package for containing an article in an assembled position in accordance with a further non-restrictive illustrative embodiment of the present disclosure;

FIG. 7A is a lateral sectional view of the theft prevention device of FIG. 5 mounted to the package; and

FIG. 7B a lateral sectional view of the theft prevention device of FIG. 5 being removed from the package.

FIG. 8 is perspective view of yet another theft prevention device and a package for containing an article in an assembled position in accordance with a further non-restrictive illustrative embodiment of the present disclosure;

FIG. 9 is a perspective view of a theft prevention device in accordance with a non-restrictive illustrative embodiment of the present disclosure;

FIG. 10A is a perspective view of a theft prevention device in accordance with another non-restrictive illustrative embodiment of the present disclosure;

FIG. 10B is a perspective top view of the base of the device of FIG. 1 in accordance with a non-restrictive illustrative embodiment of the present disclosure;

FIG. 100 is a top view of an adhesive material between the base of FIG. 10B and a package in accordance with a non-restrictive illustrative embodiment of the present disclosure;

FIG. 11 is a perspective view of a theft prevention device in accordance with a further non-restrictive illustrative embodiment of the present disclosure;

FIG. 12A is a perspective view of a package to be used in combination with a theft prevention device in accordance with a non-restrictive illustrative embodiment of the present disclosure;

FIG. 12B is a perspective view of a theft prevention device mounted to the package of FIG. 12B in accordance with a non-restrictive illustrative embodiment of the present disclosure;

FIG. 13 is front elevational view of a theft prevention device in accordance with a non-restrictive illustrative embodiment of the present disclosure; and

FIG. 14 is front elevational view of a theft prevention device in accordance with another non-restrictive illustrative embodiment of the present disclosure;

### DETAILED DESCRIPTION OF ILLUSTRATIVE EMBODIMENTS

Generally stated and in accordance with an embodiment, there is provided a theft prevention assembly comprising a base and an alarm signaling device. The base is formed on a package for packaging an article. The alarm-signaling device is mounted to the base. The device comprises a detector interfacing with the article for operative communication therewith. The detector provides for detecting an unauthorized distance between the device and the article. When the unauthorized distance is detected the device signals an alarm indicative of attempted theft. Other embodiments include devices with sockets for receiving straps to be strapped to the package.

With reference, to the appended Figures, non-restrictive illustrative embodiments will be herein described so as to further exemplify the disclosure only and by no means limit the scope thereof.

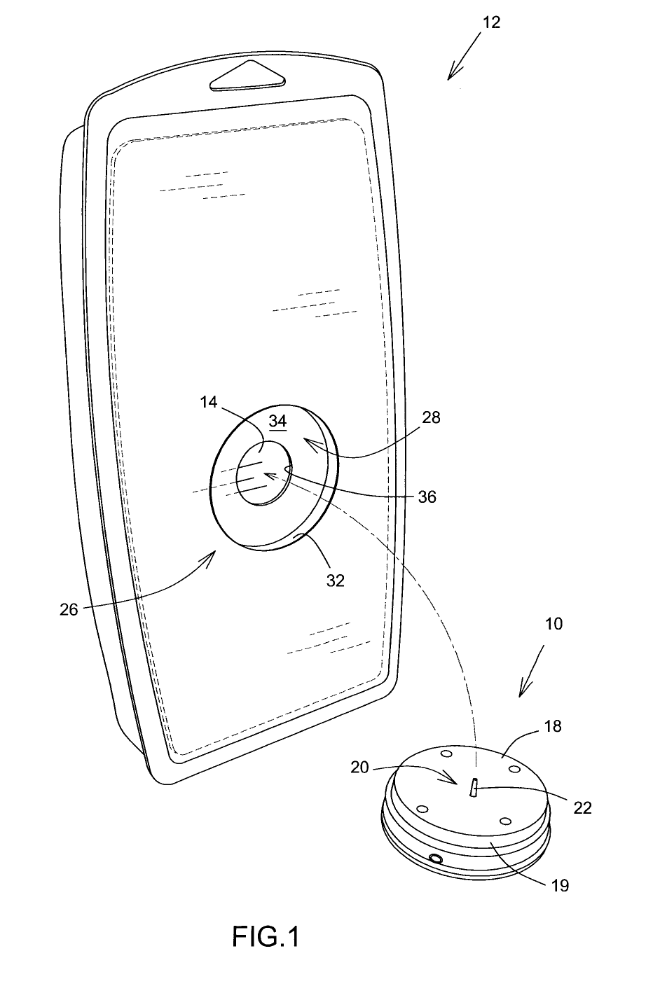

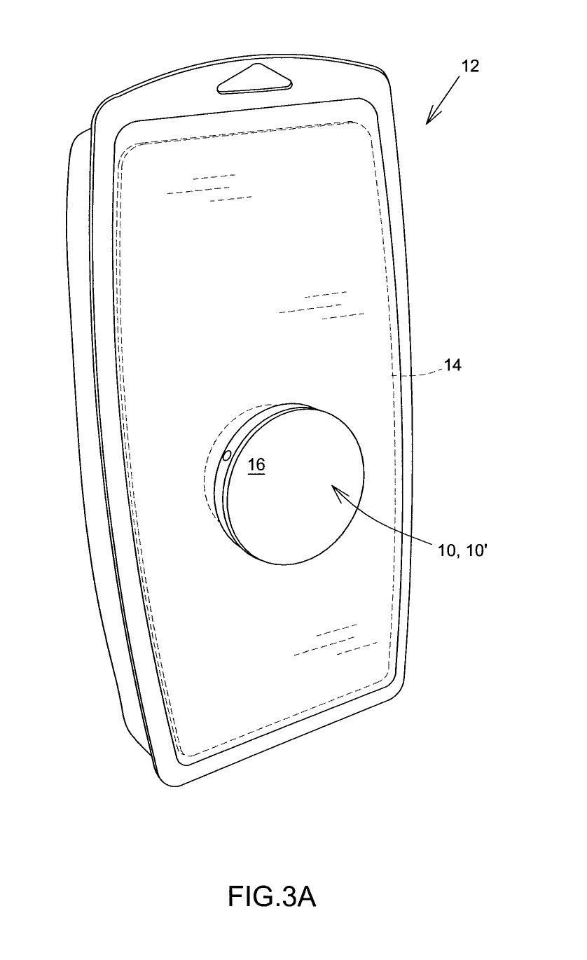

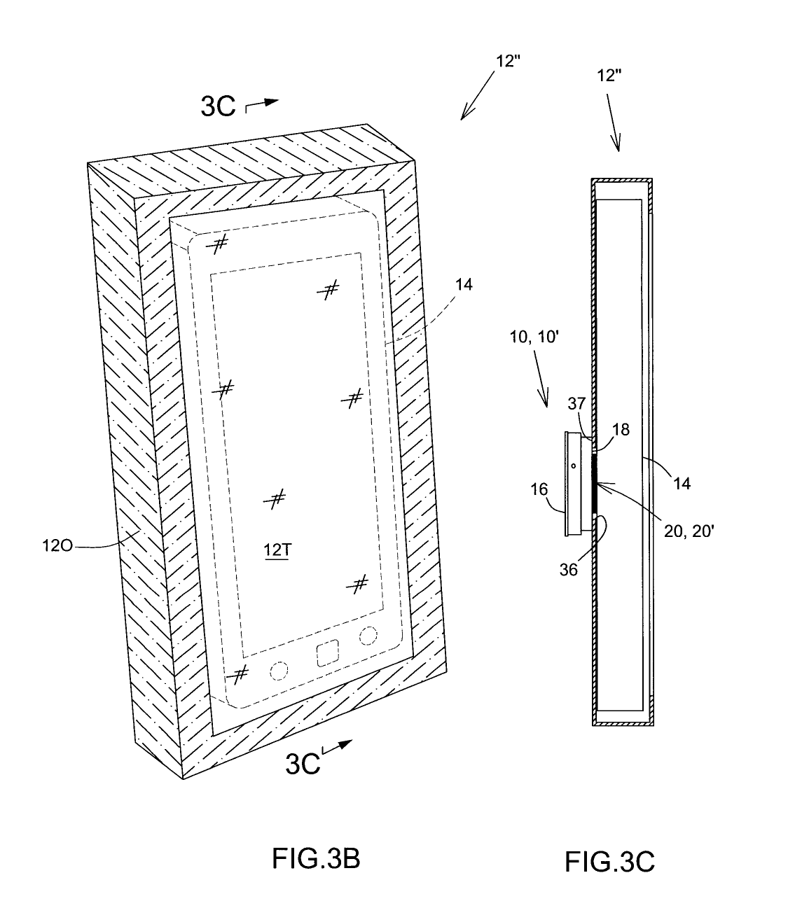

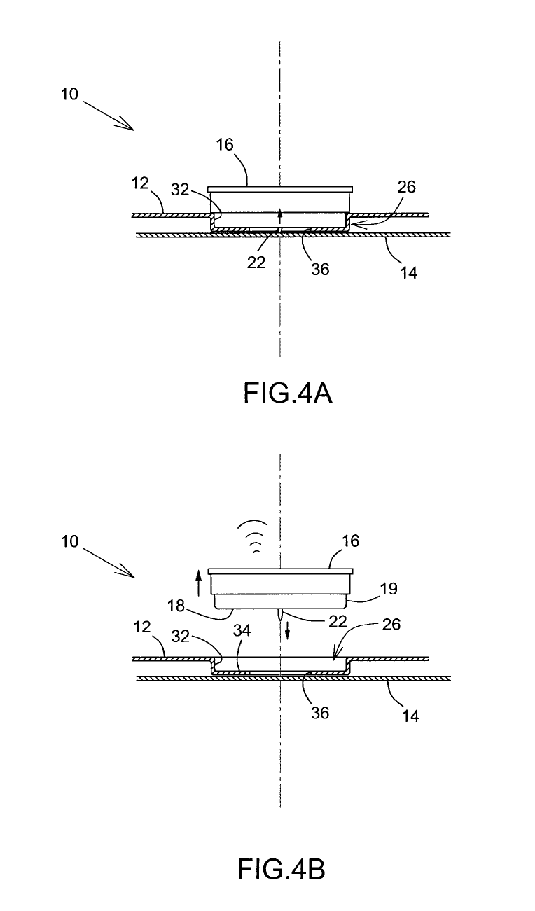

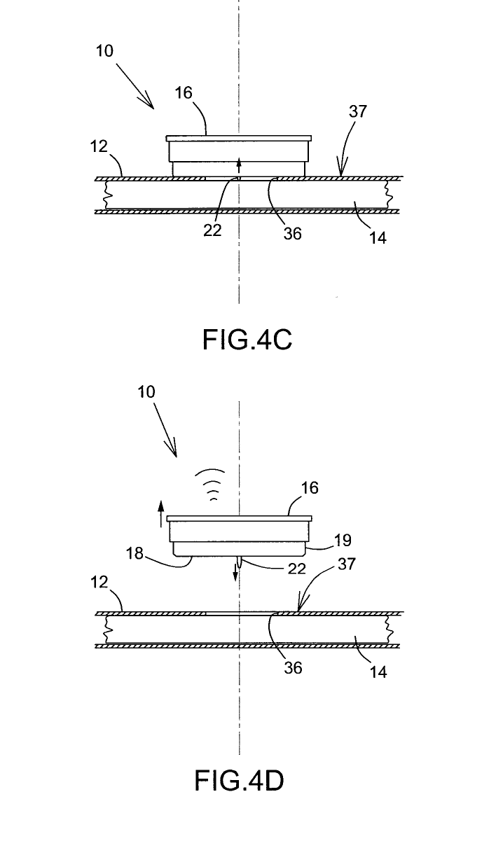

FIGS. 1 and 3 show a device 10 and package 12 for packaging an article 14 therein (see FIGS. 4A and 4B).

The device 10 houses a controller including a security tag or another EAS or RFID device therein as is known in the art. Therefore, if the device 10 is not deactivated and/or removed from the package on which it is positioned or otherwise deactivated by the salesclerk at the checkout and/or a person walks out without a valid sale, a detection system at the exit of the store detects the tag and sounds an alarm and/or signal. The device 10 can comprise for example, the various devices discussed in PCT/CA2012/000509, which is incorporated herein by reference in its entirety.

The device 10 includes a main body having a top surface 16 and a bottom surface 18 and including a median contour wall 19 therebetween. The bottom surface 18 is interfaced with the article 14 as will be described herein below. As such, the bottom surface 18 includes a detector 20 for detecting an unauthorized distance between the device 10 and the article 14.

In the present example, the detector 20 comprises a plunger 22.

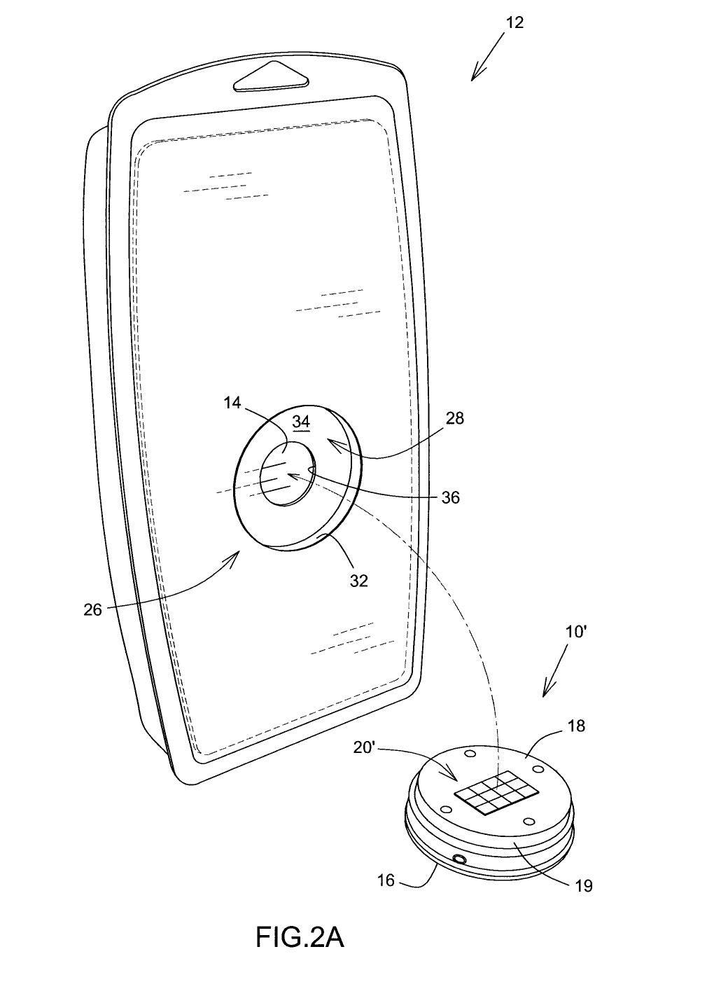

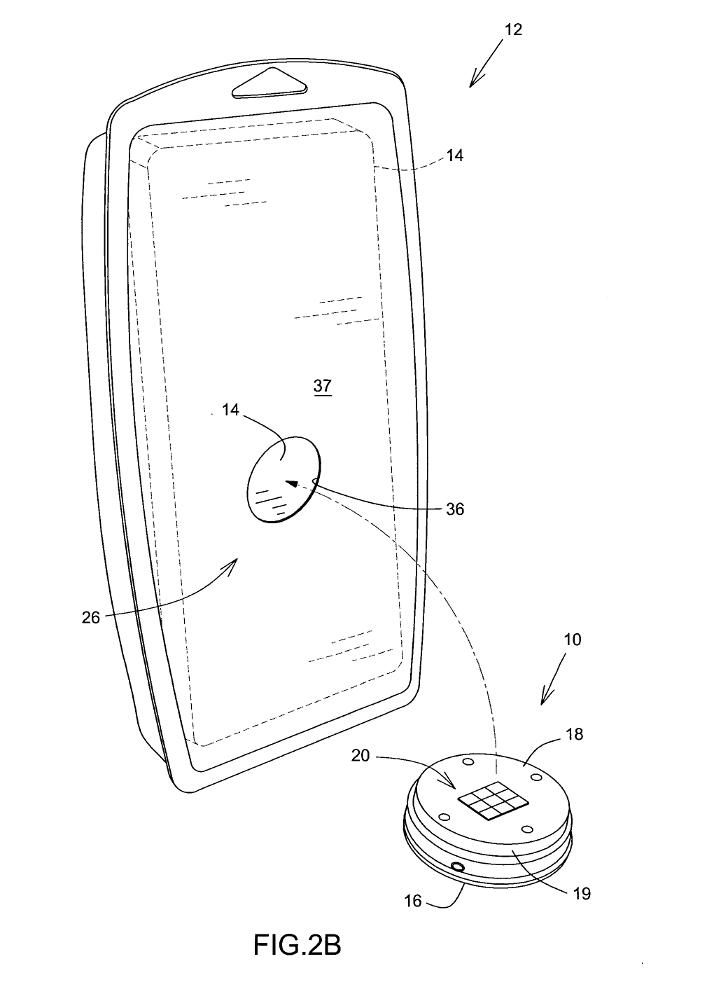

FIG. 2B shows another embodiment, in which the device 10′ is similar to device 10, except that the detector 20′ comprises a light capturing panel. The light capturing elements described herein can provide for capturing both visible and non-visible light (infrared etc.) that is “external” to the package. The expression “external” defines light not produced by the package or the device itself and thus foreign to the assemblies of packages and devices described herein which is indicative of unauthorized distance between the device and the packages.

The package 12 includes a packaging material 34 which defines a preformed integral base structure 26. The base 26 defines a recess or cavity 28 for receiving or nesting therein the device 10. The cavity 28 is bounded by a border wall 30 defining an inner wall surface 32. The inner wall surface 32 includes mating elements for mutual engagement with like mating elements formed on the median contour wall 19 of the device 10. As such, the device 10 is snap fitted into the base 26. The base 26 includes a floor 34 defining a junction 36 at which the article 14 and the detector 20 interface.

In one embodiment shown in FIG. 1, the junction 36 comprises an opening formed in the floor 34 which exposes a portion of the article 14 within the package 12 so that the detector 20 operatively communicates therewith by engaging the exposed portion. In on example, this engagement is provided by the plunger 22.

In another embodiment shown in FIG. 2A, the junction 36 comprises a window formed in the floor 34 and made of material that allows for light to pass therethrough (translucent material for example). Operative communication between the detector 20′ and the article 14 is provided by the foregoing mutual interfacing at a distance therebetween that blocks light from passing through the window and reaching the detector 20′, which in this non-limiting example is shown to be a light panel. Once an unauthorized distance is produced between the article 14 and the detector, light will pass through the window 36 and reach the panel 20. This light is thus captured by the electronic solar panel 20′ which in turn generates energy that is processed by the internal electronics of the device 10′ including a controller which is programmed to sound the alarm or signal. Furthermore, the solar panel captures light if the device 10 is lifted from the base or cavity and consequently triggers an alarm or signal. Of course, the junction 36 may include no material at all and be an opening as in FIG. 1.

FIG. 3A is shows the device 10 or 10′ of mounted to the package 12.

FIG. 2B shows a package 12′ without the recess or cavity 28, the junction 36 is simply an opening or holed formed along the same plane at the outer surface 37 of the package 12, the outer surface adjacent the opening or hole 36 defines the base formed on the package for receiving thereon the device 10′.

With reference to FIGS. 4A and 4B, when the device 10 is mounted to the base 26 formed on the package 12, its bottom surface 18 is positioned on the base floor 34 thereby providing for the detector 20 to engage the article 14 via the opening 36. As shown, in FIG. 4A, when the detector 20 engages the article 14 and the device 10 is activated, the device is in a non-signaling position. When an unauthorized distance is produced between the device 10 and the article 14 as shown in FIG. 4B, the device 10 is an alarm signaling position. In this case, the detector 20 is provided in the exemplified form of a plunger 22. Thus in the non-signaling position the plunger 22 is pushed inwardly into the body of the device 10 as the bottom surface 18 engages the surface of the article 14. The plunger 22 is outwardly biased as is known in the art, thus movement between the article 14 and the bottom surface 18 provides a space for the plunger 22 to move outwardly. An alarm is signaled at a predetermined outward movement of the plunger 22 so as to avoid false alarms during authorized handling of the package.

FIGS. 4C and 4D show the device 10 with a plunger 22 mounted to a package 12′ without a recess 28, therefore, the base is formed by the outer surface 37 of the package 12 surrounding the opening or hole 36. As such, the device 10 is mounted directly on the outer surface 37 of the package 12′ and functions as described above for FIGS. 4A and 4B.

The devices of the disclosure can be equipped with warning beeps to be used before or after activation to indicate a pre-alarm status. Also, the controller may optionally be equipped with an alarming delay to reduce false alarms during application.

When device 10′ (having a detector 20′ which is a light capture panel) as exemplified in FIGS. 2A and 2B, is mounted to the base 26 of package 12 or to the contour surface 37 (which acts as a base) surrounding the of hole 36 of package 12′, the article 14, the base bottom side 18 and the packages 12 or 12′ cover the panel 20′ from light. When an unauthorized distance is produced between the device 10′ and the article 14, the panel 20′ is exposed to light and signals an alarm.

Turning to FIGS. 3B and 3C, there is shown another package 12″, made out of preformed material, such as plastic (for example a blister pack). This material is generally translucent and as such, most of the material is obscured. Therefore, package 12″ provides for an obscured portion 12O and a translucent portion 12T allowing viewing of the article 14 therethrough. The package 12″ includes a window (made of material that permits light to pass therethrough) or opening (such as hole) 36 which provides for a detector 20 or 20′ at the bottom surface 18 of the device 10 or 10′ to interface and operatively communicate with the article 14 via the window or opening 36 when the device 10 or 10′ is mounted to the package 12″ and sits on the outer surface 37″ (i.e. base) thereof surrounding the window or opening 37.

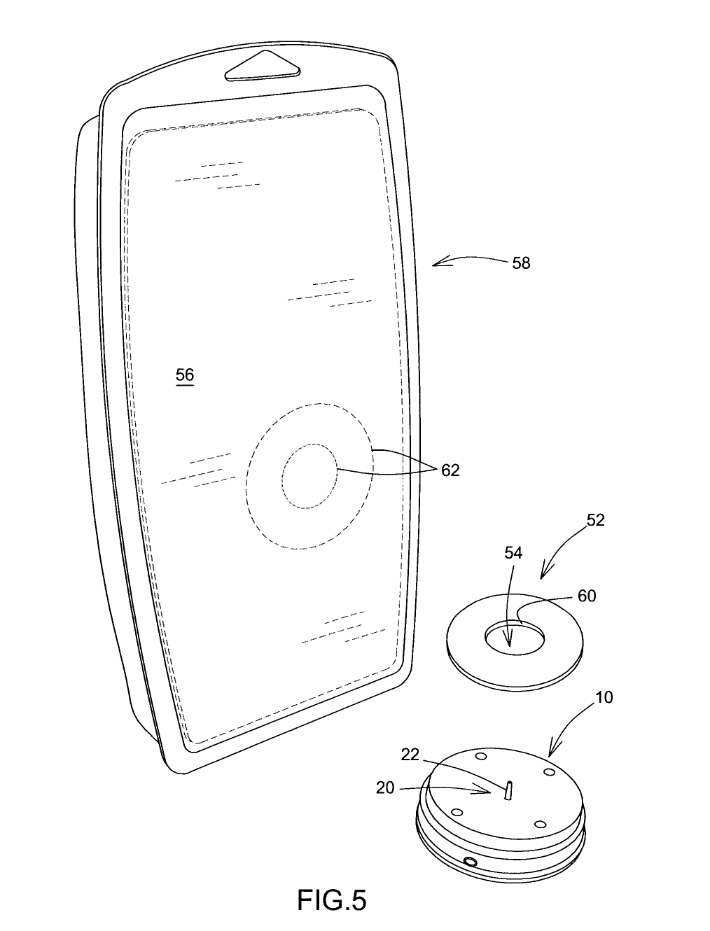

Turning to FIG. 5, there is shown a kit 50 comprising a device 10 and a cut-out element in the form of a disc 52. The disc 52 comprises a central hole 54 for allowing the user to cut a similar hole on the surface 56 of a package 58 by cutting along the inner edge 60 a disc 52 circumscribing the hole 54. As such, the device 10 can be mounted on the package via an adhesive substance for example and the detector 20 can engage the article within the package 58 as previously described. In another embodiment, the disc 52 can act as a base and be mounted to the package 58 and the device can be mounted directly on the disc base 52.

In yet another embodiment, the package 58 may be provided with preformed cut or weak lines 60 that can be removed to expose the article via a window and provide for mounting the device on the package 58 such that it directly engages the article as previously described.

Therefore, the present disclosure provides a package for a kit, the kit including a device to be mounted to the package. The package can be made of a variety of materials such as cellophane and include preformed or custom cut out areas with weak lines to have portions of the package removed so as to expose the article therein and provide a base cavity for the device which is placed in operational communication with the article.

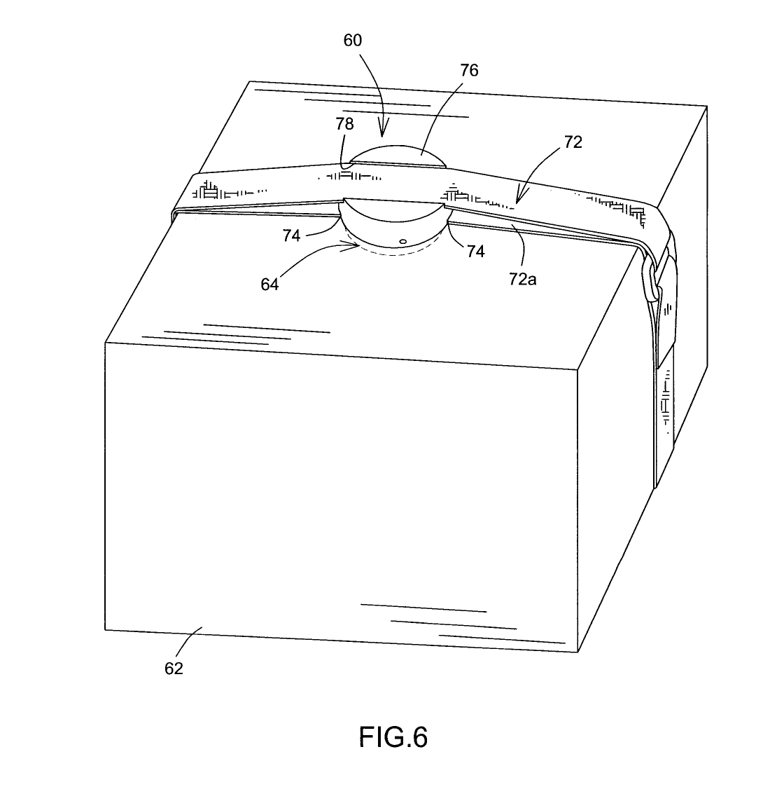

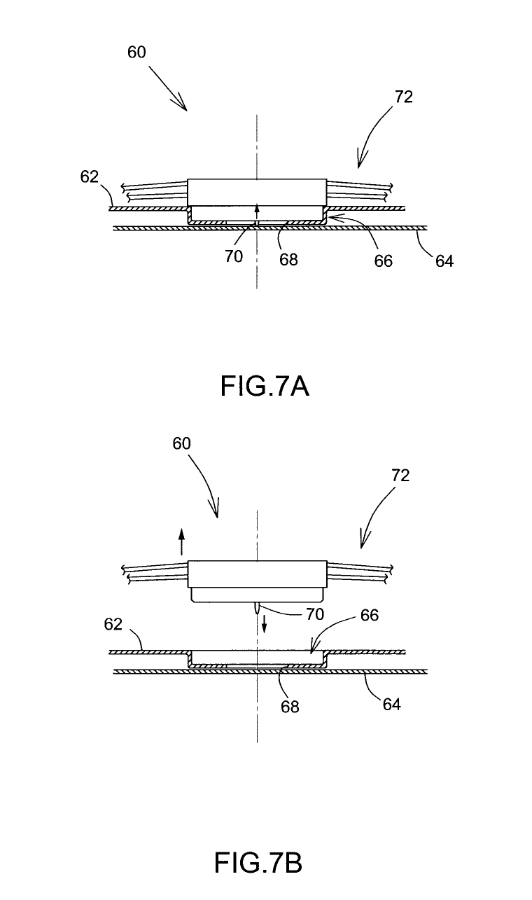

FIGS. 6, 7A and 7B show a device 60, mounted to a package 62 for holding an article 64 therein. The package 62 includes a base 66 for receiving the device 60. The base 64 defines a junction 68 at which the detector 70 of the device 60 and article 64 interface for mutual operative communication. The device 60 is also mounted to the package 62 via a strap 72.

As such the device 60 includes opposite sockets 74 with a passage (not shown) there between, to receive a first portion 72a of the strap 72. The strap 72 is looped around the package 62 and a second strap portion 72b is positioned on the top face 76 optionally of the device which defines a longitudinal recess 78 for snuggly receiving the strap 72. The two strap portions 72a and 72b are bounded together. In one embodiment, this bond is provided by an adhesive. In another embodiment, the bond is provided by a loop and hook system. A variety of alternatives for mating the strap portions together can be contemplated within the scope of the present disclosure.

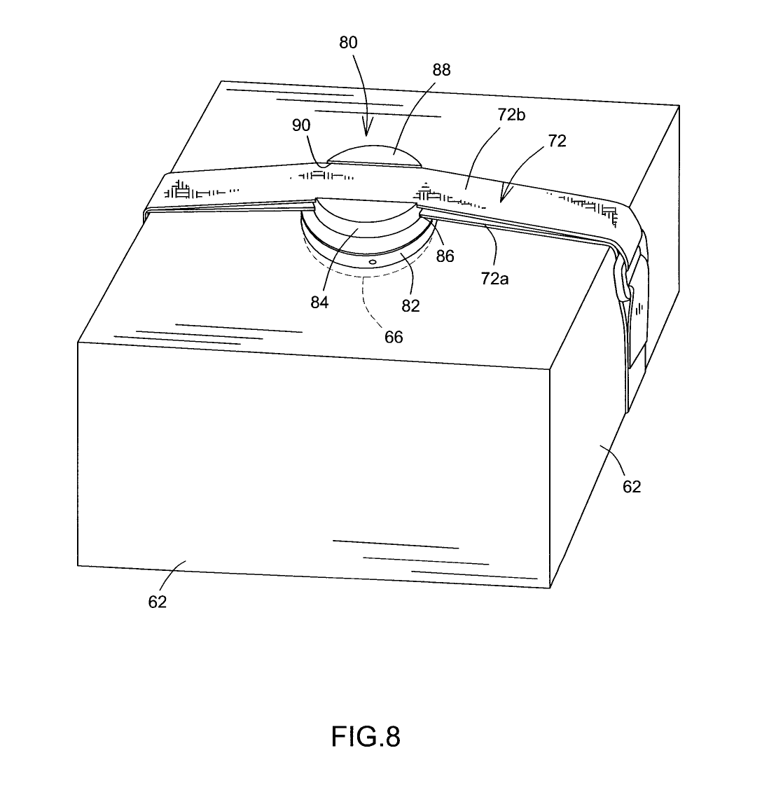

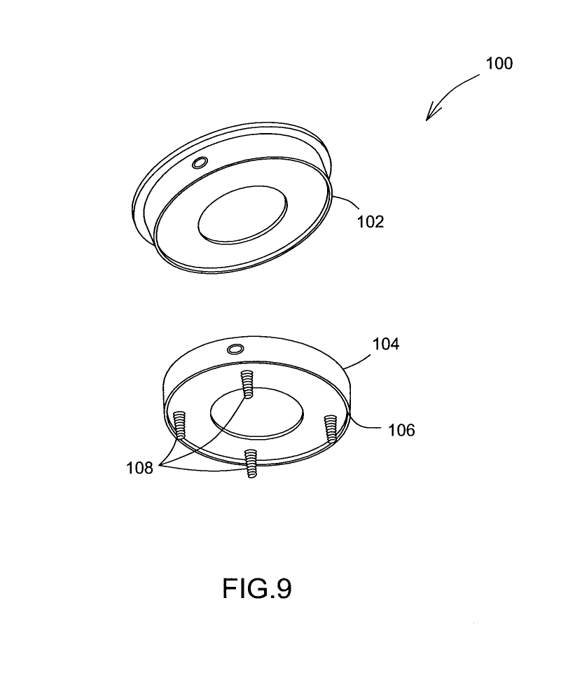

FIG. 8 shows a device 80, comprising a base 82 and an additional top piece 84 snap fitted onto to the base 82 which is mounted to the package 62 for holding an article therein. The package 62 includes a base cavity 66 for receiving the base 82. The top piece 84 includes lateral sockets 86 for receiving the strap portion 72a and a top face 88 with a recess 90 for receiving the strap portion 72b.

FIG. 9 shows a device 100 comprising a main unit 102 and a base 104 having an underside 106 with biasing elements such as springs 108. The biased base 104 enables for an alarm to be triggered quickly when the straps are loosened. Base 104 also prevents against thieves who will try to slide a flat object under the detector (plunger) to prevent it from engaging and going into alarm.

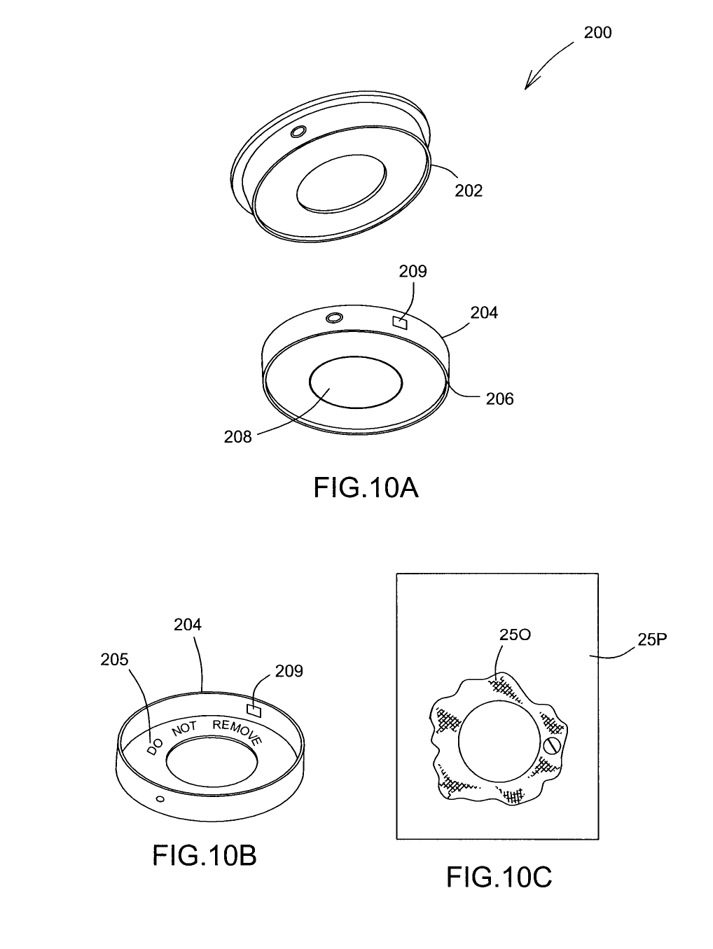

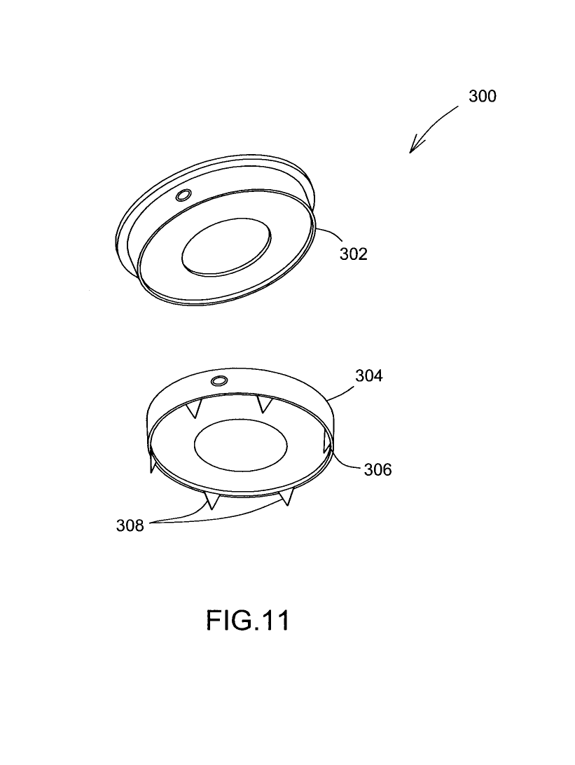

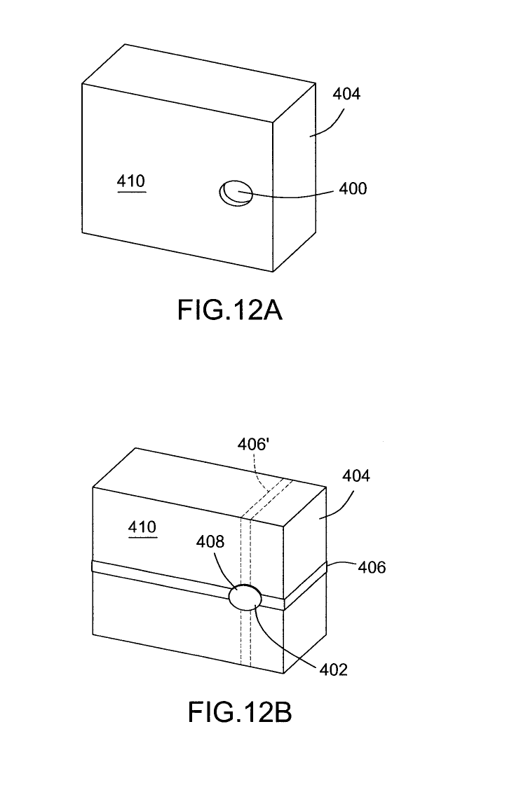

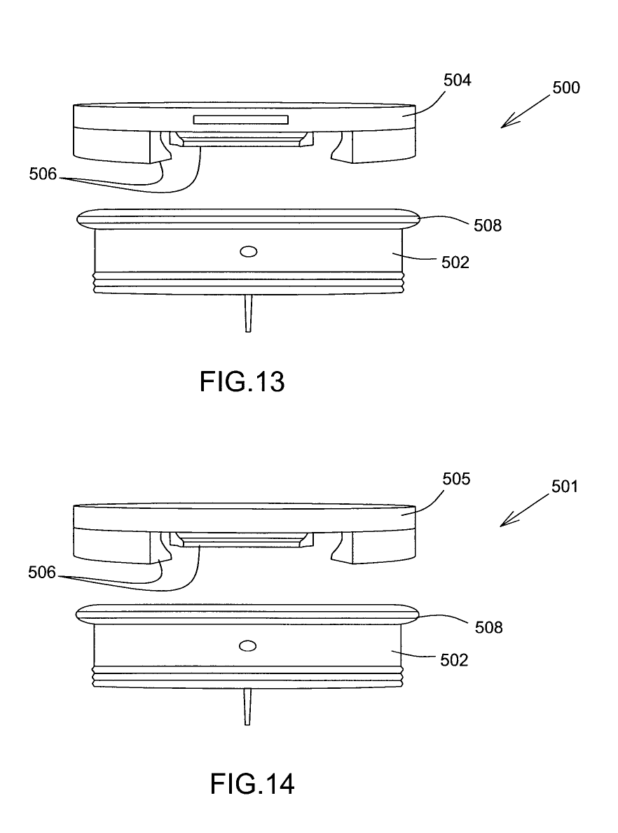

FIG. 10A shows a device 200 comprising a main unit 202 and a base 204 having an underside 206 with a collar structure 208 which prevents against thieves who will try to slide a flat object under the detector (e.g. plunger) to prevent it from engaging and going into alarm. It should be noted, as shown in FIG. 10A that the base 204 may optionally include an EAS, RFID chip 209 and like elements.

FIG. 10B shows the base with a “do not remove” tag on its inner surface 205 (the surface on which the main unit 202 sits on). For returning purchased packages, customers can be advised to not remove the base 204 from the package, as such making it more difficult for thieves to falsely return stolen packages (to request false reimbursement) which were successfully stolen by removing the base 204 or tearing or otherwise cutting off the portion of the package on which the base 204 was mounted to.

FIG. 10C shows an adhesive material 250 mounted to a package 12P for adhering a variety of alarm signaling devices to the package 12P. The adhesive material 250 includes an indicator 252 (e.g., tag, color, message, chip, symbol, etc.). The presence of the indicator 252 on a package 12P provides for the retailer to identify whether a return package was legitimately purchased or stolen, since its absence would suggest that the portion of the package that should have included the indicator 252 was tampered with in order to remove the alarm signaling device mounted thereto.

It should be noted that the various tags and chips described herein can be mounted to packages as well as articles and devices in order to create a code-correspondence between a given article, its package and/or its alarm signaling device.

FIG. 11 shows a device 300 comprising a main unit 302 and a base 304 having an underside 306 with claw structures 308. The base 304 is convenient for corrugated boxes and the like and is also prevents against thieves who will try to slide a flat object under the detector (e.g. plunger) to prevent it from engaging and going into alarm.

FIGS. 12A and 12B show a kit 400 comprising an anti-theft device 402 strapped onto a package 404 via a strap 406 (a second strap 406′ or additional straps may also be sued). The package 404 includes a receiving cavity 406 for the device 402 which is deep enough for the top surface 408 of the device 402 to lie almost flush with external package surface. The foregoing configuration provides for vertically stacking packages 404, with each upper package sitting on the surface 410 containing the device 402 within the cavity 406.

The device and strap assemblies shown in FIGS. 6, 8, 12A and 12B can also be mounted on the flat outer surface of the package without the use of a package having a preformed base, cavity, hole, window or the like.

FIG. 13 shows a device 500 including a main body 502 and a top auxiliary body 504 including bottom teeth 506 to mate with the top edges 508 of the main body. The top auxiliary body includes sockets 510 for straps. FIG. 13 shows a device 501 which is similar to device 500 with the exception that the auxiliary body 505 does not include strap sockets.

The devices of the present disclosure can include an RFID tag or EAS circuits that can be used in many ways in retail.

Moreover, the top modular pieces that snap on to bases or main units or cavities whether using straps or not can on for the strap version not only can contain a RFID circuit or an EAS circuit (commonly referred to as a AM or RF tag).

This gives the option of snapping onto another tag thereby providing the modular embodiments of the present devices.

Further non-illustrated and non-restrictive embodiments below.

The plungers described herein can comprise a variety of known plunger types, one additional example of which is an extensible touch plunger which communicates directly with an item or article. In an embodiment, there is provided se an extensible switch for modifying the length of the plunger by adding to the switch little pieces, such as capsules, that snap together thus extending the switch in order to touch the article inside the package.

For smaller items, a tie-wrap or like element is mounted to the item and the detector (e.g. sensor) which detects an unauthorized distance between the device and the article and thereby causes signaling of the alarm.

In another embodiment, the detector comprises a wire extending therefrom and being mounted to the article via the opening. The detector includes a sensor which senses any pull or tension on the wire is indicative of the unauthorized distance between the device and the article.

In an embodiment, the detector of the devices herein, comprises an infrared (IR) emitter/detector, which detects the authorized and unauthorized distance between the article and the device through the window or opening.

In another embodiment, the detector comprises a motion detector for which detects the authorized and unauthorized distance between the article and the device through the window or opening.

In another embodiment, detector comprises an image capture device such camera for which detects the authorized and unauthorized distance between the article and the device through the window or opening.

In another embodiment, the detector captures the light condition between the interfacing device and article, for example, the initial authorized condition is indicative of the initial position of the device interfacing with the article at a pre-determined authorized distance therefrom. The detector thus captures a changed light condition which, is indicative of a change in the aforementioned pre-determined authorized distance, thus the detector detects an unauthorized distance between the device and the article and as such signals the alarm.

A variety of types of detectors for the purposes discussed herein can be contemplated by the skilled artisan within the scope of the present disclosure.

Of course, in each case described herein and as mentioned before, warning signals (such as beeps) are signaled at given distance thresholds to deter continued unauthorized handling of the device and/or package.

In should be noted that a variety of separate body bases (for receiving main units of the devices as discussed herein) can be used, such as and without limitation to threaded wall bases to screw in the main unit or body of the devices. In another non-limiting embodiment, the separate body base comprises flat profile version with now peripheral walls for receiving thereon the main unit or body of the device which defines the outer peripheral walls of the device. These separate body bases can be removable and as such a low bond adhesive can be used to mount them to their package. Of course, the present disclosure also provides for not using an additional body base and simply mounting the single piece device onto the package which acts as a base, either in a base recess for nesting the device or on the contour surface which acts as base (in one non-limiting example comprising a flat outer surface) and which surrounds the window or the opening for providing interfacing of the article and the device. In either of the foregoing cases, an adhesive can also be used between the device and the package.

The devices herein have been shown with generally circular configurations, it is to be understood that any other suitable or desirable configuration can also be provided within the scope of the present disclosure including without limitation rectangular, triangular, trapezoidal, tubular structures and the like.

The shapes and sizes of the packages shown herein are for illustrative purposes only. In an embodiment, the package could also have a hole or window which could be indicated to later receive an adhesive base. The base cavity formed in the package is advantageous since it facilitates stacking.

The various features described herein can be combined in a variety of ways within the context of the present disclosure so as to provide still other embodiments. As such, the embodiments are not mutually exclusive. Moreover, the embodiments discussed herein need not include all of the features and elements illustrated and/or described and thus partial combinations of features can also be contemplated. Furthermore, embodiments with less features than those described can also be contemplated. It is to be understood that the present disclosure is not limited in its application to the details of construction and parts illustrated in the accompanying drawings and described hereinabove. The disclosure is capable of other embodiments and of being practiced in various ways. It is also to be understood that the phraseology or terminology used herein is for the purpose of description and not limitation.

Hence, although the present disclosure has been provided hereinabove by way of non-restrictive illustrative embodiments thereof, it can be modified, without departing from the scope, spirit and nature thereof and of the appended claims.

What is claimed is:

1. A theft prevention assembly comprising:
a base formed on a package for packaging an article; and
an alarm-signaling device for being mounted to the base, the device comprising a detector interfacing with the article for operative communication therewith, the detector providing for detecting an unauthorized distance between the device and the article,
wherein when the unauthorized distance is detected the device signals an alarm indicative of attempted theft.

2. A theft prevention assembly according to claim 1, wherein the base includes an opening for exposing the article therein thereby providing the operative communication between the detector and the article.

3. A theft prevention assembly according to claim 1, wherein the article and the detector interface at a junction defined by the base, wherein the base includes a window at the junction.

4. A theft prevention assembly according to claim 3, wherein the window comprises translucent material for permitting light to pass therethrough.

5. A theft prevention assembly according to any one of claims 1 to 4, wherein the base formed on the package comprises an exterior surface area of the package.

6. A theft prevention assembly according to any one of claims 1 to 4, wherein the base formed on the package comprises a recessed portion of the package for nesting the alarm-signaling device therein.

7. A theft prevention assembly according to any one of claims 1 to 4, wherein the base formed on the package comprises an additional element mounted to the package.

8. A theft prevention assembly according to any one of claims 1 to 4, wherein the base formed on the package comprises elements protruding from the package for receiving the alarm-signaling device.

9. A theft prevention assembly according to any one of claims 2 and 5 to 8, wherein the detector comprises a movable pin member engaging the article via the opening.

10. A theft prevention assembly according to any one of claims 2, and 5 to 8, wherein the detector comprises a movable wire member engaging the article via the opening.

11. A theft prevention assembly according to any one of claims 1 to 8, wherein the detector comprises a light capturing element.

12. A theft prevention assembly according to claim 10, wherein the alarm signaling device, the article and the package provide for blocking external light from being captured by the light capturing element when there is an authorized distance between the alarm-signaling device and the article.

13. A theft prevention assembly according to any one of claim 10 or 11, wherein the light capturing element captures light when there is an unauthorized distance between the alarm signaling device and the article.

14. A theft prevention assembly according to claim 11, wherein the light capturing element is configured to detect modifications in the light condition between the device and the article.

15. A theft prevention assembly according to any one of claims 1 to 8, wherein the detector comprises an infrared emitter/detector for determining the distance between the device and the article.

16. A theft prevention assembly according to any one of claims 1 to 8, wherein the detector comprises a motion detector.

17. A theft prevention assembly according to any one of claims 1 to 8, wherein the detector comprises an image capture device.

18. A theft prevention kit comprising:
a package for packaging an article therein, the package comprising an outer surface defining a base; and
an alarm-signaling device for being mounted to the base, the device comprising a detector interfacing with the article for operative communication therewith, the detector providing for detecting an unauthorized distance between the device and the article,
wherein when the unauthorized distance is detected the device signals an alarm indicative of attempted theft.

19. A theft prevention kit according to claim 18, wherein the base includes an opening for exposing the article therein thereby providing the operative communication between the detector and the article.

20. A theft prevention kit according to claim 19, wherein the article and the detector interface at a junction defined by the base, wherein the base includes a window at the junction.

21. A theft prevention kit according to claim 20, wherein the window comprises translucent material for permitting light to pass therethrough.

22. A theft prevention kit according to any one of claims 18 to 21, wherein the base formed on the package comprises an exterior surface area of the package.

23. A theft prevention kit according to any one of claims 18 to 21, wherein the base formed on the package comprises a recessed portion of the package for nesting the alarm-signaling device therein.

24. A theft prevention kit according to any one of claims 18 to 21, wherein the base formed on the package comprises an additional element mounted to the package.

25. A theft prevention kit according to any one of claims 18 to 21, wherein the base formed on the package comprises elements protruding from the package for receiving the alarm-signaling device.

26. A theft prevention kit according to any one of claims 19 and 22 to 25, wherein the detector comprises a movable pin member engaging the article via the opening.

27. A theft prevention assembly according to any one of claims 19, and 22 to 25, wherein the detector comprises a movable wire member engaging the article via the opening.

28. A theft prevention assembly according to any one of claims 18 to 25, wherein the detector comprises a light capturing element.

29. A theft prevention kit according to claim 28, wherein the alarm signaling device, the article and the package provide for blocking external light from being captured by the light capturing element when there is an authorized distance between the alarm-signaling device and the article.

30. A theft prevention kit according to any one of claim 28 or 29, wherein the light capturing element captures light when there is an unauthorized distance between the alarm signaling device and the article.

31. A theft prevention kit according to claim 28, wherein the light capturing element is configured to detect modifications in the light condition between the device and the article.

32. A theft prevention kit according to any one of claims 18 to 25, wherein the detector comprises an infrared emitter/detector for determining the distance between the device and the article.

33. A theft prevention kit according to any one of claims 18 to 25, wherein the detector comprises a motion detector.

34. A theft prevention kit according to any one of claims 18 to 25, wherein the detector comprises an image capture device.

35. A package for packaging an article therein comprising:
a base structure formed on an outer surface of the package, the base structure providing for receiving an alarm-signaling device and comprising an inner wall for mating with an outer wall of the device; and
an opening formed within a floor of the base for exposing the article within the package and for providing the device to directly engage the article,
wherein unauthorized disengagement of the device from the article is causes the device to signal an alarm indicative of attempted theft.

36. A package according to claim 35, wherein the base formed on the package comprises a recessed portion of the package for nesting the alarm-signaling device therein.

37. A package according to claim 35, wherein the base formed on the package comprises an additional element mounted to the package.

38. A package according to claim 35, wherein the base formed on the package comprises elements protruding from the package for receiving the alarm-signaling device.

39. A package according to any one of claims 35 to 38, wherein the device comprises a movable pin member engaging the article via the opening.

40. A package according to any one of claims 35 to 38, wherein the device comprises a light capturing element engaging the article.

41. A package according to claim 40, wherein the alarm signaling device, the article and the package provide for blocking external light from being captured by the light capturing element when there is engagement between the alarm-signaling device and the article.

42. A package according to any one of claim 40 or 41, wherein the light capturing element captures light when there is unauthorized disengagement between the alarm signaling device and the article.

43. A package according to claim 40, wherein the light capturing element is configured to detect modifications in the light condition between the device and the article.

44. A package according to any one of claims 35 to 38, wherein the detector comprises an infrared emitter/detector for determining the distance between the device and the article.

45. A package according to any one of claims 35 to 38, wherein the detector comprises a motion detector.

46. A package according to any one of claims 35 to 38, wherein the detector comprises an image capture device.

47. A package for packaging an article therein comprising:
a base structure formed on an outer surface of the package, the base structure providing for receiving an alarm-signaling device and comprising an inner wall for mating with an outer wall of the device,
a window formed within a floor of the base for allowing light to pass therethrough when the article within the package is at an unauthorized distance from the device when mounted to the base.

48. A package according to claim 47, wherein the window comprises translucent material for permitting light to pass therethrough.

49. A package according to any one of claim 47 or 48, wherein the base formed on the package comprises a recessed portion of the package for nesting the alarm-signaling device therein.

50. A package according to any one of claim 47 or 48, wherein the base formed on the package comprises an additional element mounted to the package.

51. A package according to any one of claim 47 or 48, wherein the base formed on the package comprises elements protruding from the package for receiving the alarm-signaling device.

52. A package according to any one of claims 47 to 51, wherein the device comprises a light capturing element.

53. A package according to claim 52, wherein the alarm signaling device, the article and the package provide for blocking external light from being captured by the light capturing element when there is an authorized distance between the alarm-signaling device and the article.

54. A package according to any one of claim 52 or 59, wherein the light capturing element captures light when there is an unauthorized distance between the alarm signaling device and the article.

55. A package according to claim 52, wherein the light capturing element is configured to detect modifications in the light condition between the device and the article.

56. A package according to any one of claims 47 to 51, wherein the detector comprises an infrared emitter/detector for determining the distance between the device and the article.

57. A package according to any one of claims 47 to 51, wherein the detector comprises a motion detector.

58. A package according to any one of claims 47 to 51, wherein the detector comprises an image capture device.

59. A package according to any one of claims 47 to 58, wherein the package comprises pre-formed packaging material.

60. A package according to claim 59, wherein the preformed packaging material is opaque.

61. A method of packaging an article comprising:
providing an material for packaging the article therein;
providing a translucent portion on the material for allowing viewing of the article therein;
obscuring the remaining portion of the material so as to block external light from passing therethrough;
providing an area on the remaining obscured portion of the material for allowing external light to pass therethrough; and
mounting an alarm signaling device on the area so as to block external light from passing therethrough, the alarm signaling device comprising a light capturing element interfacing with the article, the alarm signaling device,
wherein the article and the obscured package material provide for blocking external light from being captured by the light capturing element when there is an authorized distance between the alarm-signaling device and the article,
wherein the light capturing element captures light when there is an unauthorized distance between the alarm signaling device and the article.

62. A method according to claim 61, wherein the area comprises a window.

63. A method according to claim 62, wherein the window comprises translucent material

64. A method according to claim 61, wherein the area comprises an opening.

65. A method of packaging an article comprising:
providing a material for packaging the article therein;
forming a base structure on an outer surface of the material the base structure providing for receiving an alarm-signaling device and comprising an inner wall for mating with an outer wall of the device;
providing an opening in a floor of the of the base for exposing the article within the package and for providing the device to engage the article.

66. A method of packaging an article comprising:
providing a material for packaging the article therein;
forming a base structure on an outer surface of the material the base structure providing for receiving an alarm-signaling device and comprising an inner wall for mating with an outer wall of the device;
providing a window in a floor of the of the base for allowing light to pass therethrough when the article within the package is at an unauthorized distance from the device when mounted to the base.

67. A kit for theft prevention comprising:
a cut-out element for forming an opening on a surface of a package packaging an article; and
an alarm-signaling device for being mounted to the package, the device comprising a detector for operatively engaging the article via the opening, the detector providing for detecting an unauthorized distance between the device and the article,
wherein when the unauthorized distance is detected the device signals an alarm indicative of attempted theft.

68. A kit for theft prevention comprising:
a package for packaging an article for material having a weak cut lines for being selectively removed to provide an opening exposing the article therein; and
an alarm-signaling device for being mounted to the package, the device comprising a detector for operatively engaging the article via the opening, the detector providing for detecting an unauthorized distance between the device and the article,
wherein when the unauthorized distance is detected the device signals an alarm indicative of attempted theft.

69. A kit for theft prevention comprising:
a device for being mounted on a package having an article therein and comprising sockets; and
at least one strap for being positioned within the sockets and being strapped around the package.

70. A kit according to claim 69, further comprising a package having a base for receiving the device.

72. A kit according to claim 69, further comprising a package having a cavity for receiving the device.
